(19) United States
(12) Patent Application Publication
(10) Pub. No.: US 2024/0281176 A1
(43) Pub. Date: Aug. 22, 2024

(54) INFORMATION PROCESSING APPARATUS, CONTROL METHOD OF INFORMATION PROCESSING APPARATUS, AND NON-TRANSITORY COMPUTER-READABLE STORAGE MEDIUM

(71) Applicant: CANON KABUSHIKI KAISHA, Tokyo (JP)

(72) Inventor: TAKAHIRO SOMA, Ibaraki (JP)

(21) Appl. No.: 18/444,461

(22) Filed: Feb. 16, 2024

(30) Foreign Application Priority Data
Feb. 21, 2023 (JP) 2023-024844

(51) Int. Cl. G06F 3/12

(52) U.S. Cl. CPC G06F 3/1206; G06F 3/1246; G06F 3/1248; G06F 3/1287; G06F 3/1288

(57) ABSTRACT

According to embodiments of the present disclosure, an information processing apparatus includes a conversion unit configured to convert a file of a first format output by an application into a file of a second format, a generation unit configured to generate print data based on the converted file, and a transmission unit configured to transmit the print data generated by the generation unit, wherein the transmission unit is configured to transmit the file output by the application without conversion based on a user's instruction to transmit the file output by the application without conversion.

### BACKGROUND

### Field of the Disclosure

The present disclosure relates to an information processing apparatus, a control method of an information processing apparatus, and a non-transitory computer-readable storage medium.

### Description of the Related Art

General-purpose printer drivers (local printer drivers) that communicate with a printer using an industry standard protocol such as the Internet Printing Protocol (IPP) have been discussed in recent years. General-purpose printer drivers (cloud printer drivers) that communicate with a cloud print service have also been discussed.

A general-purpose printer driver can communicate with printers of a plurality of printer vendors, and the user can transmit print data to printers or cloud print services and print the print data without installing a vendor-specific printer driver.

Because the foregoing general-purpose printer drivers (local printer drivers and cloud printer drivers) handle print jobs to be printed by printers of various vendors, the items and functions settable as print settings are limited. In view of this, Japanese Patent Application Laid-Open No. 2021-124791 discusses a method for extending a print queue linked with a printer driver using identification information about a printer linked with the printer driver. Extending setting items unable to be set by a general-purpose printer driver using the printer's capability information acquired from a cloud print service have also been discussed. A vendor-specific print setting screen and print job edit functions unable to be set by only a general-purpose printer driver can thereby be implemented.

In printing using the foregoing general-purpose printer drivers, an operating system (OS) of an information processing apparatus generates an Extensible Markup Language (XML) Paper Specification (XPS) file based on drawing information output from an application. A print setting extension application can print the XPS file by converting the XPS file generated by the OS into a Portable Document Format (PDF) file or predetermined raster data and transmitting the PDF file or the raster data to a printer.

In opening a PDF file and printing the PDF file using a general-purpose printer driver, drawing image quality can be degraded during data conversion if the PDF file is once converted into an XPS file and a PDF file is generated again. On the other hand, converting a PDF file once into an XPS file enables processing difficult to implement with the PDF file intact, such as changing layout and adding a copy-forgery-inhibited pattern image.

### SUMMARY

Embodiments of the present disclosure are directed to, in opening a Portable Document Format (PDF) file with an application and printing the PDF file using a general-purpose printer driver, facilitating switching whether to print the PDF file by once converting the PDF file into an Extensible Markup Language (XML) Paper Specification (XPS) file or without the conversion.

According to embodiments of the present disclosure, an information processing apparatus includes a conversion unit configured to convert a file of a first format output by an application into a file of a second format, a generation unit configured to generate print data based on the converted file, and a transmission unit configured to transmit the print data generated by the generation unit, wherein the transmission unit is configured to transmit the file output by the application without conversion based on a user's instruction to transmit the file output by the application without conversion.

Further features of the present disclosure will become apparent from the following description of exemplary embodiments with reference to the attached drawings.

### BRIEF DESCRIPTION OF THE DRAWINGS

FIG. 1 is a diagram illustrating an example of a printing system according to an exemplary embodiment.

FIGS. 2A to 2E are diagrams illustrating examples of a hardware configuration of information processing apparatuses and an image forming apparatus according to the present exemplary embodiment.

FIGS. 3A and 3B are a sequence diagram illustrating processing for installing a print setting extension application according to the present exemplary embodiment.

FIG. 4 is a diagram illustrating an example of a printer management screen displayed on a client terminal according to the present exemplary embodiment.

FIG. 5 is a diagram illustrating an example of capability information stored in a cloud print compatible printer according to the present exemplary embodiment.

FIG. 6A is a diagram illustrating an example of device configuration information bundled with an operating system (OS) according to the present exemplary embodiment.

FIGS. 6B-1 and 6B-2 are a diagram illustrating an example of device configuration information extended with information acquired from a cloud print service according to the present exemplary embodiment.

FIG. 7 is a diagram illustrating an example of an extended setup information file acquired from an online support service according to the present exemplary embodiment.

FIGS. 8A and 8B are a sequence diagram illustrating processing from the print setting by the print setting extension application to the transmission of print data according to the present exemplary embodiment.

FIGS. 9A to 9D are diagrams illustrating examples of print setting screens displayed in a case where the print setting extension application is not installed according to the present exemplary embodiment.

FIGS. 10A to 10E are diagrams illustrating an example of a print setting screen displayed in a case where the print setting extension application is installed according to the present exemplary embodiment.

FIG. 11 is a diagram illustrating an example of a print setting initial screen displayed by a document generation application according to the present exemplary embodiment.

FIG. 12 is a diagram illustrating an example of a print setting screen displayed by the print setting extension application according to a first exemplary embodiment.

FIGS. 13A and 13B are a flowchart illustrating processing performed by a client terminal according to the first exemplary embodiment.

FIG. 14 is a diagram illustrating an example of a print setting screen displayed by the print setting extension application when a Portable Document File (PDF) pass-through function is not usable according to the first exemplary embodiment.

FIG. 15 is a diagram illustrating an example of a print setting screen displayed by a print setting extension application according to a second exemplary embodiment.

FIGS. 16A and 16B are a flowchart illustrating processing performed by a client terminal according to the second exemplary embodiment.

FIG. 17 is a diagram illustrating an example of information about a page description language (PDL) type processible by the cloud print compatible printer, written to device capability information according to the first exemplary embodiment.

### DESCRIPTION OF THE EMBODIMENTS

Exemplary embodiments of the present disclosure will be described below with reference to the drawings.

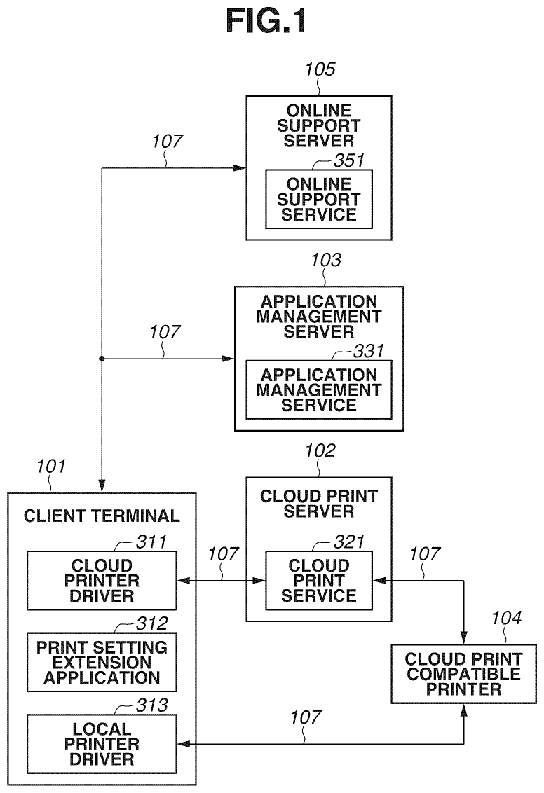

FIG. 1 illustrates a configuration diagram of a printing system for cloud printing according to a first exemplary embodiment. A client terminal 101, a cloud print server 102, an application management server 103, a cloud print compatible printer 104, and an online support server 105 are connected via a network 107.

While FIG. 1 illustrates one client terminal 101 and one cloud print compatible printer 104, there may be a plurality of client terminals 101 and a plurality of cloud print compatible printers 104.

The cloud print server 102, the application management server 103, and the online support server 105 each may be a server system including a plurality of information processing apparatuses. Configuring each of the servers as a server system including a plurality of information processing apparatuses enables load distribution over the plurality of information processing apparatuses.

The cloud print server 102, the application management server 103, and the online support server 105 may be virtually configured in a physical information processing apparatus.

The network 107 is assumed to connect to cloud services using a wide area network (WAN) such as the Internet. However, the entire network 107 may be a closed environment such as a corporate local area network (LAN).

The client terminal 101 is an information processing apparatus such as a personal computer (PC), a tablet, or a smartphone, and directly operated by the user. Various pieces of application software can be run on the client terminal 101.

The cloud print compatible printer 104 is a device for actually performing printing on a recording medium such as a sheet of paper. The cloud print compatible printer 104 is an image forming apparatus that converts print data received via the network 107 into image data and prints the image data.

The cloud print compatible printer 104 can receive print data from the client terminal 101 via the cloud print server 102 or directly from the client terminal 101 without the intervention of the cloud print server 102.

The cloud print compatible printer 104 receives print data generated by a cloud printer driver 311 of the client terminal 101 via the cloud print server 102. The cloud print compatible printer 104 receives print data generated by a local printer driver 313 of the client terminal 101 without the intervention of the cloud print server 102.

The cloud print server 102 accepts print instructions and print data from outside. The cloud print server 102 transmits the received print data to a cloud print compatible printer 104 specified by the print data. In the present exemplary embodiment, image data and print settings are referred to collectively as print data.

The application management server 103 stores and manages various applications.

The application management server 103 receives identification information about an application and a download request from the client terminal 101, and transmits the application identified by the received identification information to the client terminal 101.

The online support server 105 is a server apparatus for providing an online support service 351. The online support service 351 is a service for providing the client terminal 101 with an extended setup information file describing information for extending the functions of the client terminal 101.

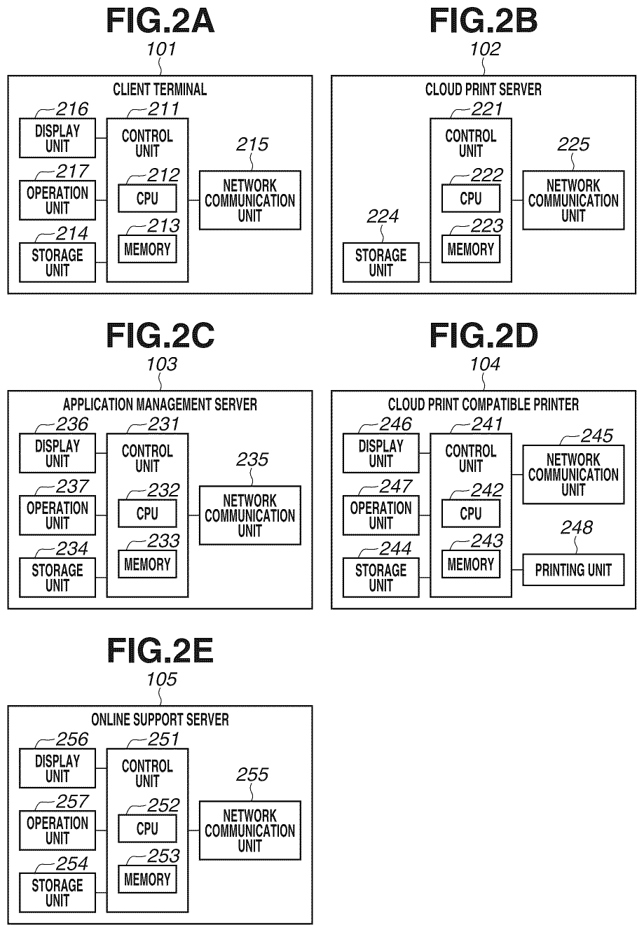

Next, a hardware configuration of the printing system according to the present exemplary embodiment will be described with reference to FIGS. 2A to 2E.

FIG. 2A is a block diagram illustrating a hardware configuration of the client terminal 101.

The client terminal 101 includes a display unit 216, an operation unit 217, a storage unit 214, a control unit 211, and a network communication unit 215.

The storage unit 214 refers to a nonvolatile storage device such as a hard disk or a solid-state drive (SSD), and can store and rewrite digital data.

The control unit 211 includes a central processing unit (CPU) 212 and a memory 213, and controls the operation of the entire client terminal 101. The CPU 212 loads a program stored in the storage unit 214 into the memory 213 and executes the program. The memory 213 is a main storage memory of the CPU 212, and used as a work area and a temporary storage area for loading various programs.

The network communication unit 215 is a device for communicating with the external network 107. The network communication unit 215 inputs and outputs digital data from/to external servers and client terminals via the network 107.

The display unit 216 is a device for displaying visual information to the user. Examples include a liquid crystal display. The operation unit 217 is a device for accepting input from the user with a keyboard and a mouse. A device having the functions of both the display unit 216 and the operation unit 217, such as a touchscreen, may be used.

FIG. 2B is a block diagram illustrating a hardware configuration of the cloud print server 102. The cloud print server 102 includes a storage unit 224, a control unit 221, and a network communication unit 225.

The storage unit 224, the control unit 221, and the network communication unit 225 are similar to those of the client terminal 101, and a description thereof will thus be omitted.

While the cloud print server 102 is described to include an information processing apparatus having the hardware configuration illustrated in FIG. 2B, the cloud print server 102 may be a server system including a plurality of information processing apparatuses.

FIG. 2C is a block diagram illustrating a hardware configuration of the application management server 103. The application management server 103 includes a display unit 236, an operation unit 237, a storage unit 234, a control unit 231, and a network communication unit 235.

The display unit 236, the operation unit 237, the storage unit 234, the control unit 231, and the network communication unit 235 are similar to those of the client terminal 101, and a description thereof will thus be omitted.

While the application management server 103 is described to include an information processing apparatus having the hardware configuration illustrated in FIG. 2C, the application management server 103 may include a plurality of information processing apparatuses.

FIG. 2D is a block diagram illustrating a hardware configuration of the cloud print compatible printer 104. The cloud print compatible printer 104 includes a display unit 246, an operation unit 247, a storage unit 244, a control unit 241, a network communication unit 245, and a printing unit 248.

The display unit 246 is a device for displaying information to the user. Examples include a touchscreen and a light-emitting diode (LED) on the cloud print compatible printer 104.

The operation unit 247 is a device for accepting input from the user. The operation unit 247 may include hardware keys, such as a numeric keypad, in addition to a touchscreen. The storage unit 244 and the control unit 241 are similar to those of the client terminal 101, and a description thereof will thus be omitted.

The network communication unit 245 is a device for communicating with the external network 107. The network communication unit 245 mainly has the functions of receiving print data and transmitting the state of the cloud print compatible printer 104, such as an error, to external servers.

The printing unit 248 is a device that performs print processing by performing a series of operations including feed, printing, and discharge operations on sheets provided in a cassette or on a tray. The printing method is not limited to electrophotographic printing or inkjet printing. A two-sided unit to be used in discharging a sheet and a finishing apparatus for stapling and punch processing are also included in the printing unit 248.

In the present exemplary embodiment, a single-function printer that performs only a print function is described as an example of the cloud print compatible printer 104. However, a multifunction printer (multifunction peripheral [MFP]) having a scanner function and a facsimile (FAX) function as well may be used.

FIG. 2E is a hardware block diagram illustrating details of the online support server 105. In the present exemplary embodiment, the online support server 105 is described to include an information processing apparatus. However, the online support server 105 may include a plurality of information processing apparatuses. The online support server 105 includes a display unit 256, an operation unit 257, a storage unit 254, a control unit 251, and a network communication unit 255. The display unit 256 and the operation unit 257 are similar to the display unit 216 and the operation unit 217 of the client terminal 101, and a description thereof will thus be omitted. The storage unit 254 is a memory device such as a hard disk drive (HDD) or an SSD. The storage unit 254 stores an extended setup information file that is a file describing information for extending the functions provided by the client terminal 101.

The control unit 251 includes a CPU 252 and a memory 253. The CPU 252 controls the entire online support server 105. The memory 253 is used for processing performed by the CPU 252. The network communication unit 255 is an interface for the online support server 105 to communicate with the client terminal 101. The online support server 105 receives an acquisition request for a file stored in the storage unit 254 and transmits the corresponding file to the client terminal 101 via the network communication unit 255.

Next, an example of the user's procedure up to installation of the print setting extension application 312 and a sequence between the pieces of software and a cloud print service according to the present exemplary embodiment will be described.

The cloud print compatible printer 104 initially accepts a printer registration operation for registering of the cloud print compatible printer 104 in a cloud print service 321 from the user. In step S3001, the cloud print compatible printer 104 then transmits device identification information about the cloud print compatible printer 104 and the printer registration request to the cloud print service 321. An example of the device identification information transmitted to the cloud print service 321 here is a hardware identifier (HWID) assigned to each printer model. The device identification information may be any information from which the printer model can be identified.

Receiving the printer registration request, the cloud print service 321 transmits a Uniform Resource Locator (URL) of the cloud print service 321 for printer registration to the cloud print compatible printer 104. When the user accesses the URL from the cloud print compatible printer 104 or an information processing apparatus, a screen including an input form for a user identifier (ID) and a password is displayed on the display unit of the terminal accessing the URL. The user inputs the user ID and the password for using the cloud print service 321, and logs in to the cloud print service 321. If the user logs in successfully, the cloud print service 321 transmits an acquisition request for information to be used for printer registration to the cloud print compatible printer 104. The cloud print compatible printer 104 transmits its printer information to the cloud print service 321 in response to the request.

Next, the cloud print service 321 receiving the printer registration request registers the printer information about the cloud print compatible printer 104, and generates a print queue for the cloud print compatible printer 104. Here, the cloud print service 321 obtains capability information about the cloud print compatible printer 104 and links the capability information with the generated print queue. Capability information refers to information indicating the functions implemented on the printer, or equivalently, information for the user to set as print settings during printing. Examples of the information include two-sided printing capability information, color capability information, stapling capability information, and image data formats processible by the printer.

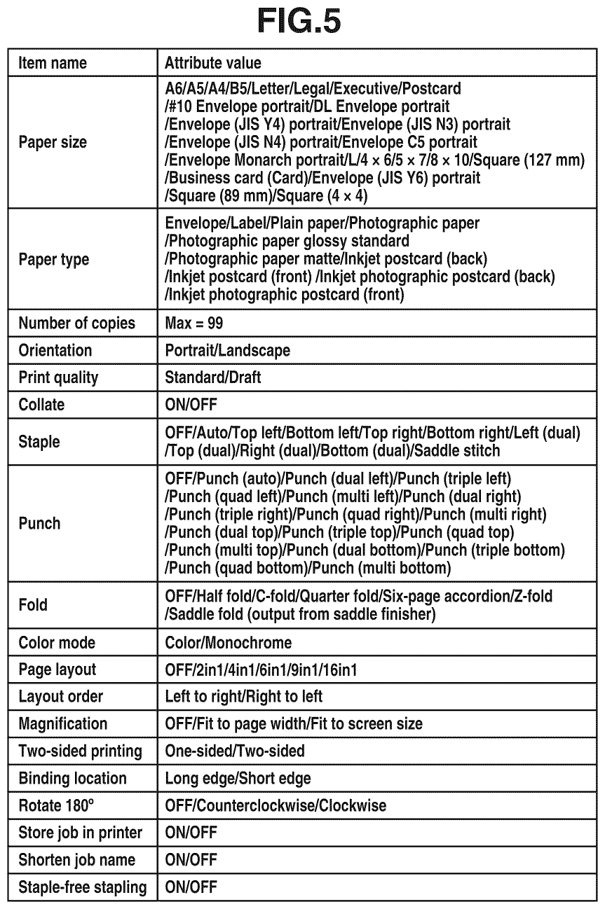

In the present exemplary embodiment, the capability information is transmitted using the Internet Printing Protocol (IPP) as the communication protocol. The cloud print service 321 thereby acquires item names, attribute values, and default values illustrated in the example of FIG. 5 from the cloud print compatible printer 104. The item names correspond to setting items of the print settings. The attribute values correspond to setting values, options, or value ranges of the respective setting items. The item names and attribute values stored in the cloud print compatible printer 104 include information defined as industry standard specifications by the IPP and information originally defined by the printer vendor. For example, “Shorten job name” and “Staple-free stapling”, among the item names illustrated in FIG. 5, and the accompanying attribute values are item names and attribute values originally defined by the printer vendor. Note that the printer vendor's original attribute values may be defined as attribute values corresponding to item names defined as industrial standard specifications. Any capability information may be used regardless of whether the item names and attribute values are defined by the IPP.

Next, the installation of the print setting extension application 312 to be performed when the user performs a setup operation to print using the cloud print compatible printer 104 on the client terminal 101 will be described.

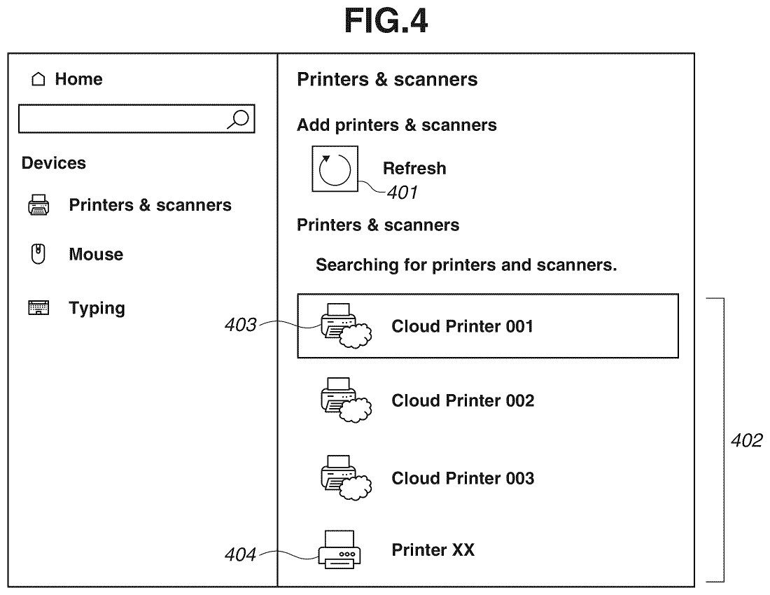

In step S3002, an operating system (OS) 313 of the client terminal 101 accepts a printer addition operation that is the setup operation of the cloud print compatible printer 104 by the user. An example of the setup operation of the cloud print compatible printer 104 will now be described. FIG. 4 is a management screen for printers registered in the client terminal 101, displayed by the OS 313 of the client terminal 101. If the user selects an object 401, a printer addition instruction is input to the OS 313.

Receiving the printer addition request, the OS 313 determines whether a token for the cloud print service 321 is stored. If the OS 313 does not have the token, the OS 313 displays a screen for inputting user information (login name and password). In step S3003, the OS 313 transmits the user information input via the screen to the cloud print service 321, and requests user authentication and an access token.

In step S3004, the cloud print service 321 performs authentication processing using the user information received from the client terminal 101. After the completion of the authentication processing, the cloud print service 321 notifies the client terminal 101 of the result of the authentication processing.

If the user authentication is successful, then in step S3005, the OS 313 of the client terminal 101 acquires an access token from the cloud print service 321.

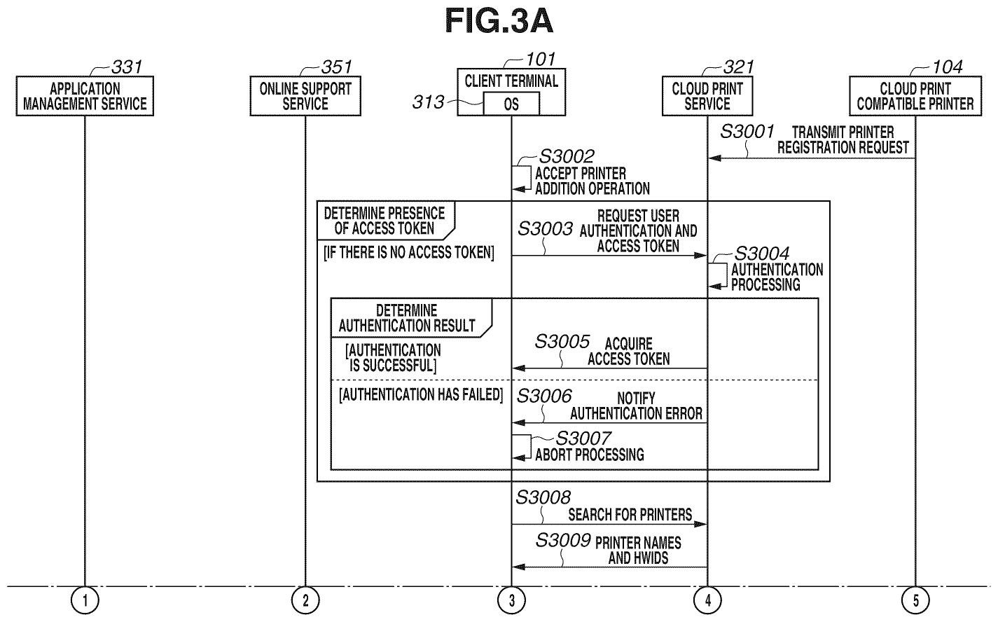

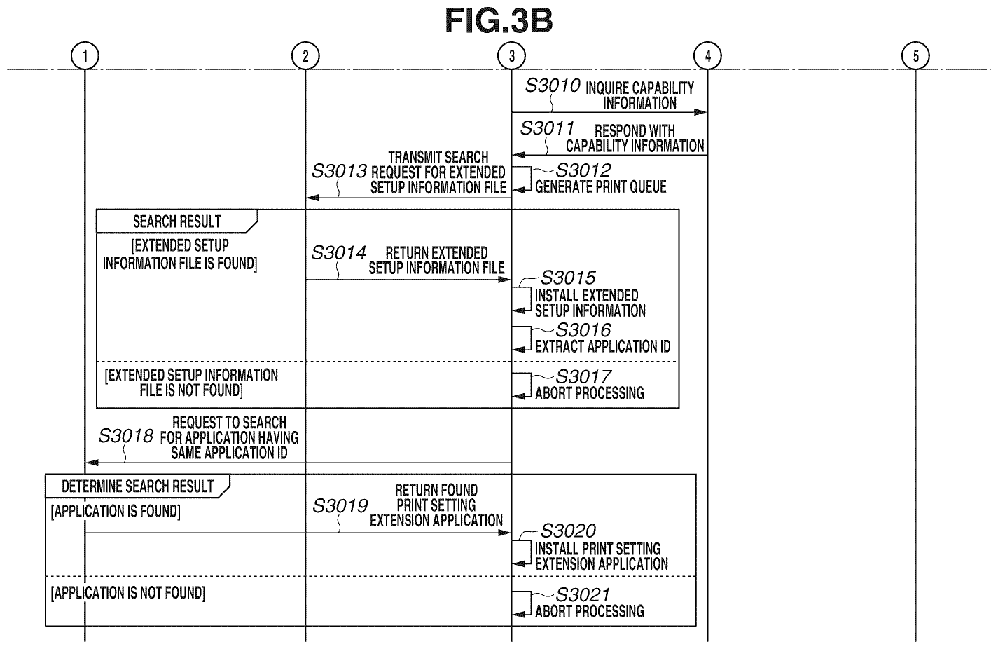

If the user authentication in step S3004 fails, then in step S3006, the cloud print service 321 notifies the OS 313 of an authentication error. In step S3007, the OS 313 aborts the processing based on the received information about the authentication error. The OS 313 that has failed to acquire the access token ends the processing illustrated in FIGS. 3A and 3B.

If the OS 313 already has the access token or the access token is acquired in step S3005, the processing proceeds to step S3008. The OS 313 searches for printers registered in the cloud print service 321 and printers connected to the network 107.

In step S3008, the OS 313 transmits an acquisition request for printer information registered in the cloud print service 321 to search for printers. Here, the OS 313 transmits to the cloud print service 321 the acquisition request for the printer information with the access token attached.

In step S3009, the cloud print service 321 transmits to the client terminal 101 the printer names and HWIDs of printers that the user identified by the access token attached to the acquisition request is permitted to use.

The OS 313 displays a list of printers in an area 402 of FIG. 4 based on the printer information acquired from the cloud print service 321 and the printer information detected by the search of the network 107. Only the information about the printers registered in the cloud print service 321 may be displayed in the area 402.

If the user selects printer information from the list in the area 402, then in step S3010, the OS 313 inquires the capability information about the printer corresponding to the selected printer information from the cloud print service 321. Which setting items of the capability information for the OS 313 to inquire is determined by the specifications of the OS 313. Using Get-Printer-Attribute defined by the IPP, the OS 313 transmits a capability information acquisition request with item names defined by the IPP as arguments to the cloud print service 321.

In step S3011, the cloud print service 321 responds to the OS 313 with the capability information about the cloud print compatible printer 104. The capability information returned from the cloud print service 321 is not limited to the capability information registered in the cloud print service 321 in step S3001, but may be capability information registered in the cloud print service 321 at other timing. For example, the capability information may be that registered at timing when the capability information about the cloud print compatible printer 104 is changed, or that at timing when the OS 313 detects the activation of a detailed print setting screen.

In step S3011, the cloud print service 321 returns attribute values and default values corresponding to the setting items specified by the client terminal 101. Here, all the attribute value registered in the cloud print service 321 are returned. If the cloud print service 321 does not store a response to the attributes inquired by the OS 313, the cloud print service 321 does not respond to the OS 313.

The OS 313 then starts installation of the cloud printer driver 311 based on the device identification information and printer name of the printer selected by the user.

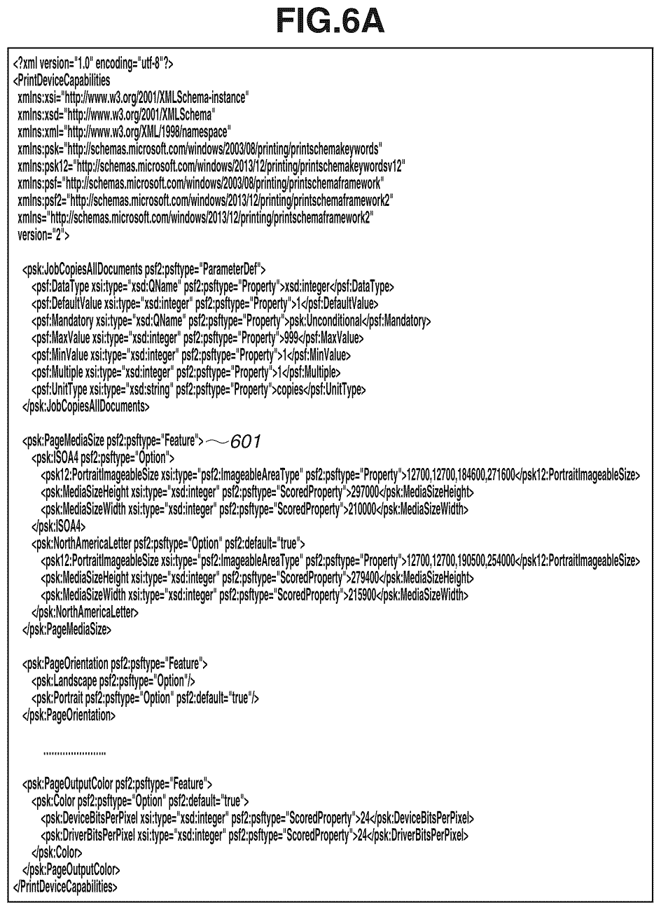

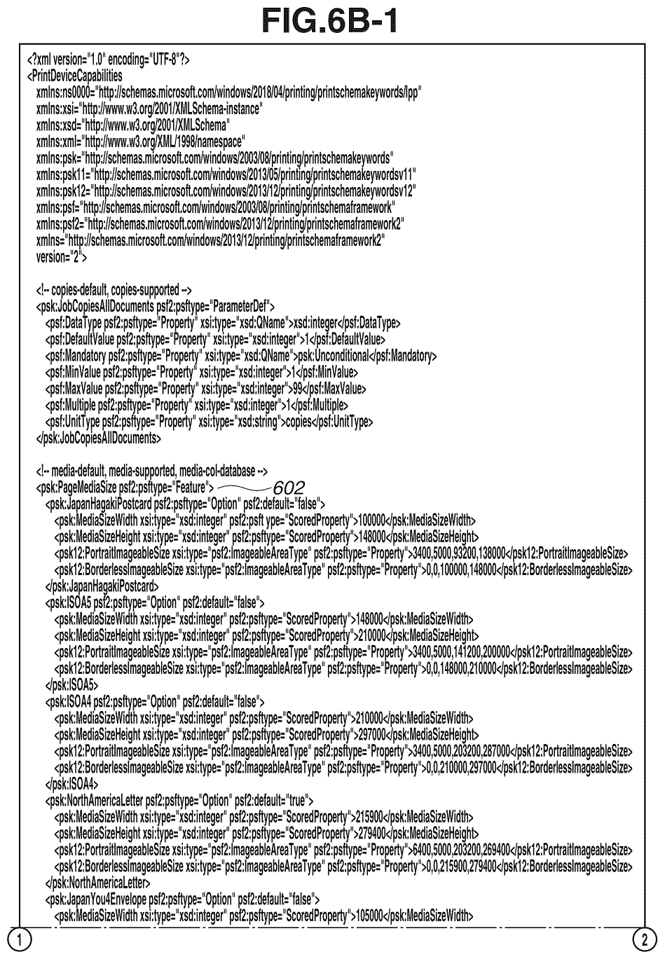

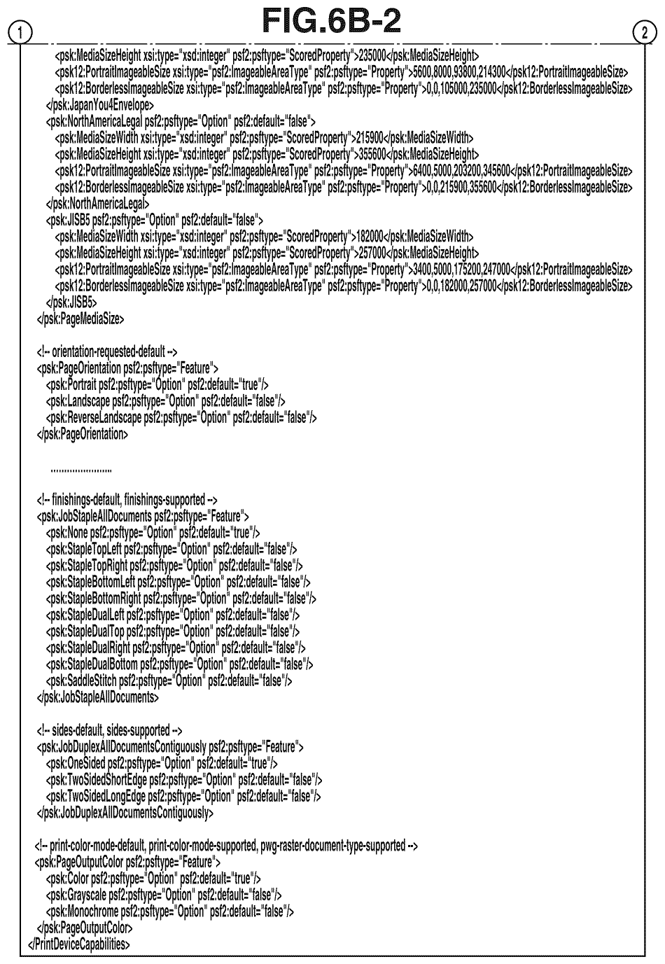

In step S3012, the OS 313 generates a print queue for the cloud printer driver 311 with basic device capability information bundled with the OS 313. Device capability information refers to definition information for generating or print setting capability information about a printer driver. Examples include definition information described in Extensible Markup Language (XML), such as PrintDeviceCapabilities. FIG. 6A is a diagram illustrating an example of the device capability information in an initial state, bundled with the OS 313. For example, a setting item “Feature” describes “PageMediaSize” 601 indicating paper sizes, where options “Option” include only two paper sizes “A4” and “Letter” as initial values of the device capability information.

Such information is stored as linked with the print queue, and managed by the OS 313. The device capability information in the initial state is fixed device capability information regardless of the information about the connected printer.

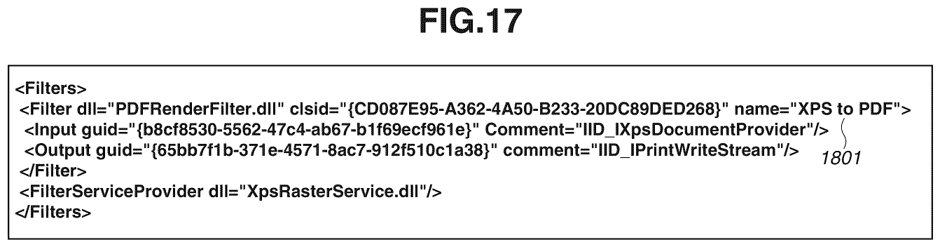

The OS 313 then updates the device capability information constituting the cloud printer driver 311, using the capability information acquired from the cloud print service 321. FIGS. 6B-1 and 6B-2 are a diagram illustrating an example of the device capability information updated using the capability information acquired from the cloud print service 321. For example, options “Option” other than “A4” and “Letter” are added to “PageMediaSize” 602 indicating paper sizes, as paper sizes printable by the cloud print compatible printer 104. In such a manner, the client terminal 101 initially registers the cloud printer driver 311 and the device capability information bundled with the OS 313 in the print queue in association with each other. The device capability information linked with the print queue is then updated with the capability information acquired from the cloud print service 321. Here, the OS 313 extends setting values by updating the device capability information using only the attribute values defined as the industry standard specifications among the pieces of capability information acquired from the cloud print service 321. If vendor-specific attribute values are acquired by the acquisition of the capability information, the vendor-specific attribute values are not added to the device capability information. The installation of the cloud printer driver 311 is thereby completed. Which format of image data the cloud print compatible printer 104 can print is defined as illustrated in FIG. 17. The definition is written to the device capability information. “XPS to PDF” 1801 in FIG. 17 is capability information indicating that the cloud print compatible printer 104 can receive and print a Portable Document Format (PDF) file. Similarly, if the cloud print compatible printer 104 can receive and print a file of a Printer Working Group (PWG)-Raster format, capability information indicating the capability is written to the device capability information.

Next, the OS 313 starts installation processing of an application that is linked with the cloud print compatible printer 104 and extends the cloud printer driver 311.

Initially, the OS 313 performs additional identification information addition processing on the device identification information. The additional identification information addition processing refers to processing for acquiring an extended setup information file 700 from the online support server 105. Additional identification information may be any character string different from normal device identification information. In the present exemplary embodiment, for the sake of distinction from the applications of other devices, the OS 313 adds additional identification information (“PrinterApp_”) indicating a printer-related application to the device identification information. “PrinterApp_” is just an example, and other character strings, numerals, and symbols may be used. If, for example, the device identification information about the cloud print compatible printer 104 is device001, the device identification information after the additional identification information addition processing is PrinterApp_device001.

In step S3013, the OS 313 transmits a search request for the extended setup information file 700 including the device identification information to which the intended additional identification information is added, to the online support service 351. Here, the online support service 351 is notified of “PrinterApp_device001” where the additional identification information is added as described above.

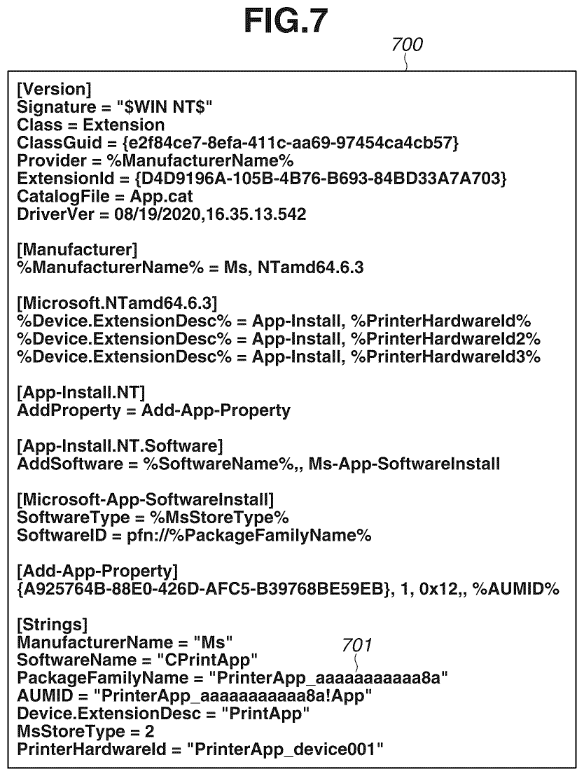

FIG. 7 illustrates an example of the extended setup information file 700. The extended setup information file 700 of FIG. 7 is stored in the searched online support service 351.

The extended setup information file 700 describes an application ID for identifying the print setting extension application 312 used in setting the print data to be transmitted to the cloud print compatible printer 104. In the extended setup information file 700 illustrated in FIG. 7, an item “PackageFamilyName” 701 describes the identification information about the print setting extension application 312. In FIG. 7, the identification information is “PrinterApp_aaaaaaaaaaa8a!App”. “PrinterHardwareId” describes the character string that is the identification information about the cloud print compatible printer 104 with the additional identification information added. In FIG. 7, the character string is “PrinterApp_device001”.

The online support service 351 also stores extended setup information describing the identification information about the printer driver. The extended setup information file 700 describing the ID of the printer driver describes the ID of the printer driver in “PackageFamilyName”. “PrinterHardwareId” of the extended setup information file 700 describes the device identification information without the additional identification information. The OS 313 thus adds the additional identification information to the device identification information to acquire the intended extended setup information file 700 from the online support service 351.

If, as a result of the search, the online support service 351 is found to have the extended setup information file 700 including the intended device identification information, then in step S3014, the online support service 351 returns the extended setup information file 700 to the OS 313. The content of the returned extended setup information file 700 is written to the registry of the OS 313.

In step S3015, the OS 313 links the extended setup information written in the extended setup information file acquired from the online support service 351 with the print queue generated in step S3012, and installs the extended setup information.

In step S3016, the OS 313 extracts the application ID described in “PackageFamilyName” from the installed extended setup information.

If, as a result of the search, the online support service 351 does not successfully detect the extended setup information file 700 including the intended device identification information, then in step S3017, the OS 313 aborts the application installation processing. The OS 313 also performs the processing of step S3017 if the extended setup information file 700 is not received within a predetermined time after the search request or if an error notification is received from the online support service 351.

Processing for the case where the search is successful will now be described.

In step S3018, the OS 313 requests the application management service 331 to search for an application having the same application ID as the extracted application ID.

If the print setting extension application 312 matching the requested application ID is stored in the search-requested application management service 331, then in step S3019, the application management service 331 returns the print setting extension application 312 matching the application ID to the client terminal 101.

In step S3020, the OS 313 installs the acquired print setting extension application 312 in association with the client-side print queue. Here, the OS 313 stores the application ID into the registry as print queue information. The print setting extension application 312 sets the OS 313 to issue an event notification at timing when the print queue linked with the print setting extension application 312 is set on a print setting screen.

The installed print setting extension application 312 is activated after activation of the OS 313, and runs as a background task.

If, as a result of the search, the print setting extension application 312 matching the requested application ID is not stored in the application management service 331, then in step S3021, the OS 313 aborts the application installation processing. Here, the processing ends with the cloud printer driver 311 installed as linked with the generated print queue, and without the print setting extension application 312 being linked with the print queue.

The foregoing search for the extended setup information file 700 may be performed without adding a predetermined character string, as long as printer driver installation files can be distinguished.

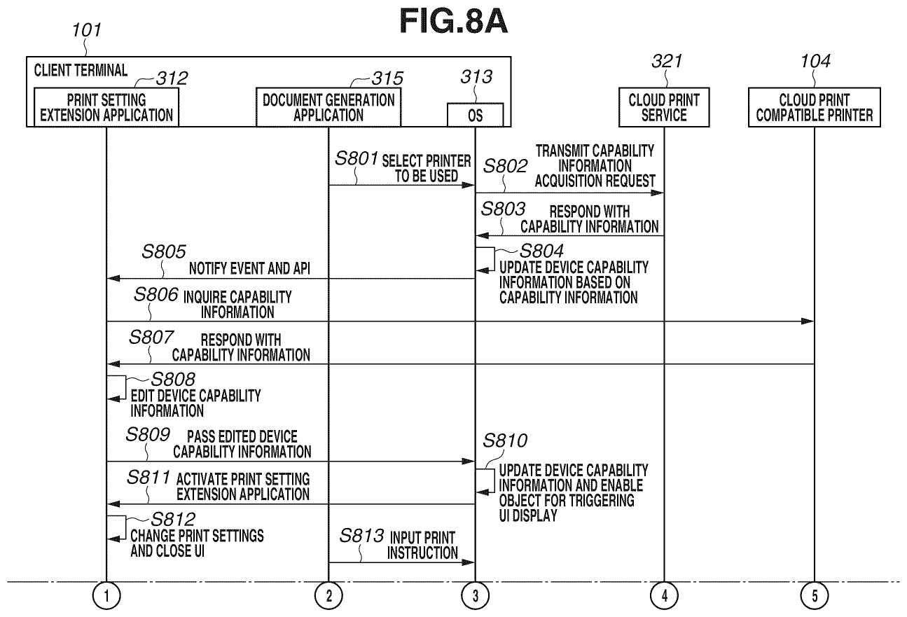

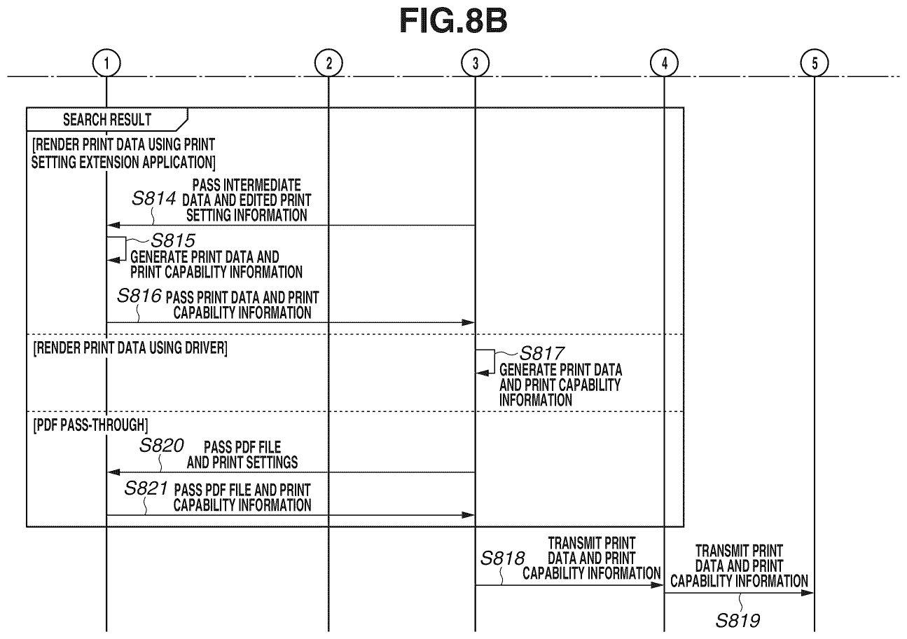

Next, an example of the user's procedure and a sequence between the pieces of software and the cloud print service 321 according to the present exemplary embodiment will be described with reference to FIGS. 8A and 8B.

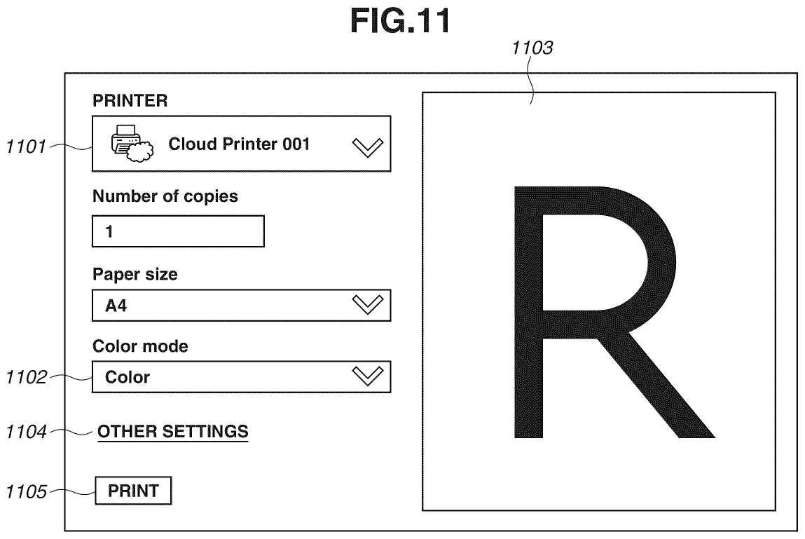

A document generation application 315 displays a print setting screen (FIG. 11) for selecting a print queue as a print setting initial screen. The document generation application 315 refers to an application such as a document data generation application, a presentation material generation application, or a photograph and image data display application.

While in the present exemplary embodiment, the document generation application 315 displays the print setting initial screen, a similar screen may be displayed by the OS 313. The print setting initial screen displays an object 1101 for selecting a print queue, an object 1102 for print setting, and a print preview 1103. In step S801, the OS 313 detects that a printer to be used is selected via the object 1101, and selects a print queue. In the following description, the print queue of a default printer shall be selected at timing when the print setting initial screen starts to be displayed.

In step S802, the OS 313 transmits a capability information acquisition request for the printer to the cloud print service 321. The OS 313 specifies the printer name selected by the object 1101 on the print setting initial screen, and transmits the capability information acquisition request to the cloud print service 321. Which setting items of the capability information to inquire depends on the specifications of the OS 313. The capability information acquired at this timing is therefore similar to that acquired in step S3001 of FIG. 3A. The inquiry is made to the cloud print compatible printer 104 using a standard protocol defined by the IPP, such as Get-Printer-Attributes. If Get-Printer-Attributes is used, the OS 313 inquires predetermined capability information in a list form.

In step S803, the cloud print service 321 returns the capability information about the cloud print compatible printer 104 to the OS 313 based on the list of capability information transmitted using Get-Printer-Attributes. Suppose, for example, that the medium size attribute is specified by Get-Printer-Attributes (IPP). If the medium size attribute is stored, the cloud print service 321 returns values linked with the attribute (such as A4, B5, and Letter).

If the print queue of the cloud print service 321 for the cloud print compatible printer 104 does not have the attribute specified by Get-Printer-Attributes, the cloud print service 321 does not respond with a linked value.

In step S804, the OS 313 updates the device capability information using the capability information acquired from the cloud print service 321. The OS 313 adds the capability information acquired in step S803 of FIG. 8A to the device capability information generated in step S3012 of FIG. 3B. If the device capability information has been updated, the device capability information managed by the client terminal 101 can be updated by performing step S804.

In step S805, the OS 313 notifies the print setting extension application 312 of the event and an application programming interface (API) to be used in editing the device capability information.

Receiving the event, the print setting extension application 312 transmits an acquisition request for capability information to the cloud print service 321. The capability information to be acquired here is that for writing of setting items and attribute values originally defined by the printer vendor into the device capability information.

In step S806, the print setting extension application 312 receiving the event to edit the device capability information from the OS 313 inquires the capability information about the cloud print compatible printer 104 via the cloud print service 321. Here, the print setting extension application 312 inquires capability information including setting items specific to the printer vendor, such as “staple-free stapling” and “saddle fold”, and setting items including attribute values specific to the printer vendor from the cloud print service 321. Like step S802 of FIG. 8A, the inquiry is made using Get-Printer-Attributes, and the capability information is acquired by specifying the item names of the setting items to be inquired. The capability information to be acquired in step S806 is not limited to the setting items and attribute values originally defined by the printer vendor, and may include setting items already acquired by the acquisition of capability information by the OS 313.

In step S807, the cloud print compatible printer 104 inquired of about the printer vendor-specific capability information by the print setting extension application 312 responds to the print setting extension application 312 via the cloud print service 321. The responding method is similar to that in step S3011 of FIG. 3B described above. In the present exemplary embodiment, in step S807, the cloud print service 321 responds with the capability information about the cloud print compatible printer 104, stored in the cloud print service 321.

Alternatively, the cloud print service 321 may respond with capability information that the cloud print service 321 re-acquires from the cloud print compatible printer 104 at the timing of reception of the request in step S806.

Acquiring the capability information from the cloud print compatible printer 104, the print setting extension application 312 edits the device capability information via configuration information objects that are a data group to edit the device capability information. In step S808, the print setting extension application 312 edits the device capability information by converting the capability information acquired in step S807 of FIG. 8A, such as “staple-free stapling”, “saddle fold”, and “page description language (PDL) type transmittable to printer”, into device capability information and adding the device capability information to the configuration information objects. As a result of the editing, the printer vendor-specific setting items and attribute values are stored in the device capability information in addition to the capability information about the standard setting items acquired by the inquiry by the OS 313.

In step S809, the print setting extension application 312 passes the edited device capability information to the OS 313. The OS 313 links the device capability information acquired from the print setting extension application 312 with the print queue, and stores the device capability information.

In step S810, the OS 313 updates the device capability information, whereby an object for triggering display of a user interface (UI) of the print setting extension application 312, such as an object 1104 of FIG. 11, is enabled. Before the processing of step S810 is completed, the object 1104 is grayed out.

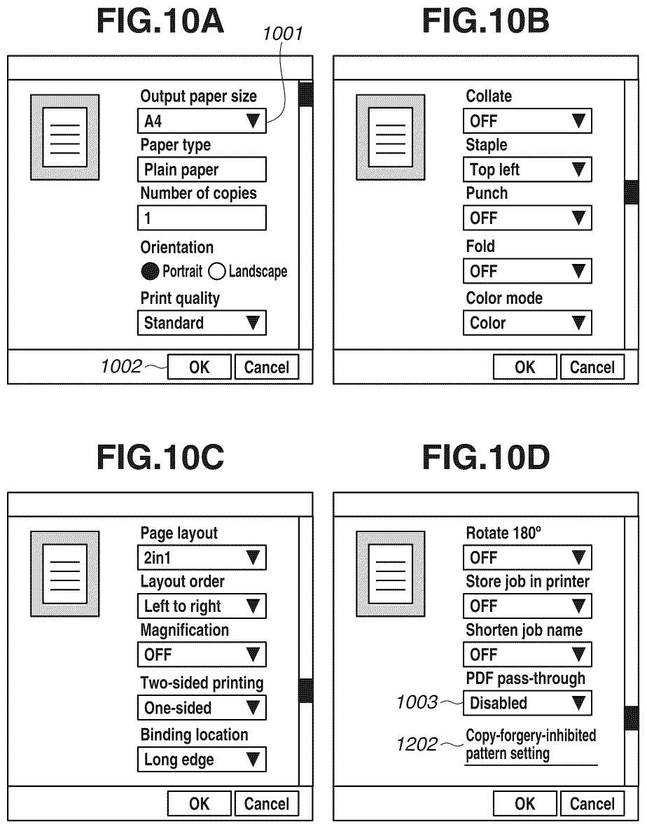

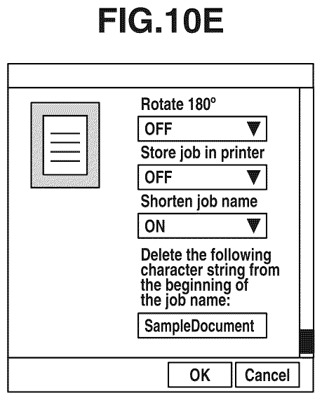

If the user selects the object 1104, then in step S811, the OS 313 activates the print setting extension application 312 and a print setting screen such as illustrated in FIGS. 10A to 10E is displayed. This print setting screen does not depend on the type of document generation application 315 to be used.

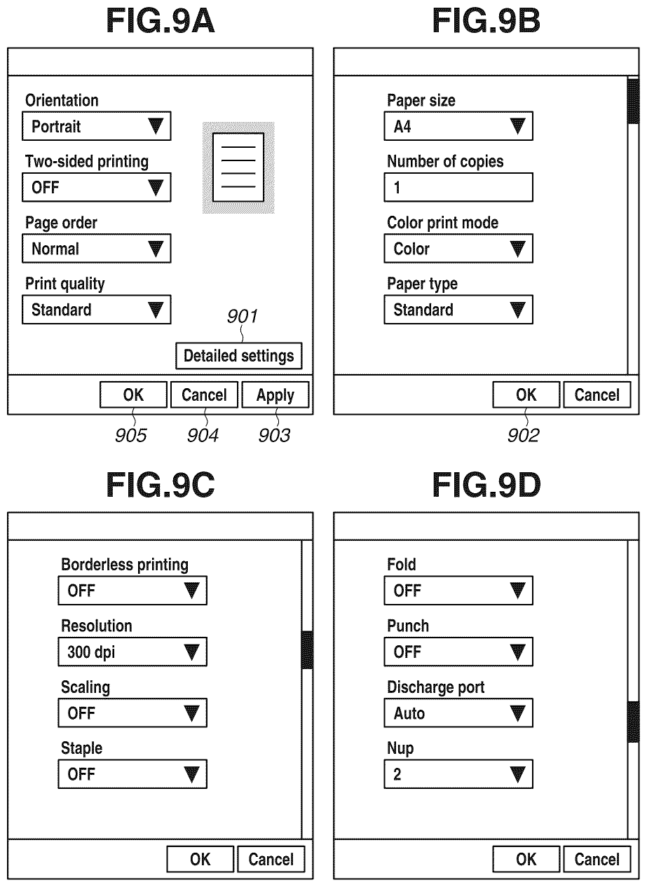

If the print queue and the print setting extension application 312 are not linked, a standard print setting screen implemented on the OS 313 in advance is displayed as illustrated in FIG. 9A. If a detailed setting button 901 on the standard print setting screen is pressed, a detailed print setting screen of FIG. 9B is displayed. The detailed print setting screen includes setting items more than can be displayed on the standard print setting screen of FIG. 9A. The detailed print setting screen illustrated in FIG. 9B supports a scrollbar, and the screen can be scrolled to set a plurality of setting items supported by the OS 313 as illustrated in FIGS. 9C and 9D. If an OK button 902 is selected, the print settings made are stored and the screen of FIG. 9A is displayed. An apply button 903 is a button to store the print settings. A cancel button 904 is a button to return to the screen of FIG. 11 without storing the print settings. Similarly, an OK button 905 is a button to store the setting items and return to the screen of FIG. 11.

Return to the description of the print setting extension application 312. The print setting extension application 312 receives print setting information generated based on the print setting capability information generated from the device capability information by the OS 313, and displays an extended print setting screen of FIG. 10A. The screens of FIGS. 10A to 10E are displayed by scrolling the extended print setting screen.

For example, a setting item 1001 “Output sheet size” in FIG. 10A displays print setting information generated from psk:PageMediaSize in FIGS. 6B-1 and 6B-2. The option “A4” of the output paper size is generated and displayed by the print setting extension application 312 based on print setting information “psk:ISOA4”. In such a manner, the print setting extension application 312 displays, as setting values, the device capability information on the extension print setting screen.

The print setting extension application 312 provides a function of freely changing the print settings by the user, and stores changed setting values. If an OK button 1002 displayed on the extended print setting screen of FIGS. 10A to 10E is selected by the user, the print settings are determined. Suppose, for example, the user changes the medium size from A4 to Letter on the UI. In such a case, the print setting information retained by the print setting extension application 312 changes from A4 to Letter.

A list box 1003 of FIG. 10D is a list box to disable and enable a PDF pass-through function. If the PDF pass-through function is disabled, a PDF file generated by the document generation application 315 is once converted into an XPS file by the OS 313. The XPS file is converted into a PDF file again by the print setting extension application 312, and transmitted to the cloud print compatible printer 104. On the other hand, if the PDF pass-through function is enabled, the PDF file generated by the document generation application 315 is simply transmitted to the cloud print compatible printer 104 without XPS conversion. The standard print setting screen displayed by the OS 313 does not display the list box 1003 to switch the PDF pass-through function on and off. If the OK button 1002 is selected by the user, then in step S812, the print setting extension application 312 acquires the print setting information processed within the control of the print setting screen from the print setting screen, passes the print setting information to the OS 313, and closes the extended print setting screen illustrated in FIGS. 10A to 10E. After the completion of the processing of step S812, the print setting initial screen of FIG. 11 on which the setting values set by the print setting extension application 312 are reflected is displayed.

If the user selects a “print” button 1105 on the print setting screen illustrated in FIG. 11, then in step S813, a print instruction is input to the OS 313. The OS 313 performs printing-related processing based on the input instruction.

In step S814, the OS 313 instructed to perform printing generates intermediate data, and passes the generated intermediate data and the print setting information edited by a print setting screen unit to the print setting extension application 312. The intermediate data refers to data generated before conversion into print data such as PDL data. Examples include XPS data. The print setting information is also included in the intermediate data.

There are the following three possible patterns of processing when the user selects the “print” button 1105 on the print setting initial screen illustrated in FIG. 11. A first pattern is where the print setting extension application 312 linked with the selected print queue is installed on the client terminal 101 and the setting of the PDF pass-through function is disabled. A second pattern is where the print setting extension application 312 linked with the selected print queue is not installed. A third pattern is where the print setting extension application 312 linked with the selected print queue is installed and the PDF pass-through function is enabled. Each of the patterns will now be described.

In the first pattern, the print setting extension application 312 corresponding to the print queue is installed on the client terminal 101 and the PDF pass-through function is disabled. The OS 313 converts the file output from the document generation application 315 into intermediate data, and transmits the converted intermediate data and the print setting information to the print setting extension application 312. In step S815, the print setting extension application 312 receives the intermediate data and the print setting information from the OS 313, and generates print data and print capability information. An example of the intermediate data is data of the XPS format. The print data refers to PDL data such as a PDF file. The print capability information refers specifically to IPP-defined attribute values of the print setting information.

In step S816, after the generation of the print data, the print setting extension application 312 passes the generated print data and the print capability information to the print queue of the OS 313. The above is the processing performed in the first pattern.

In the foregoing second pattern, the OS 313 of the client terminal 101 performs the following processing of step S817. In step S817, the OS 313 converts the data output by the document generation application 315 into intermediate data, and generates print data and print capability information from the intermediate data and the print settings.

Next, the processing in the foregoing third pattern will be described. In the third pattern, the print setting extension application 312 corresponding to the selected print queue is installed on the client terminal 101 and the setting of the PDF pass-through function is enabled. Note that the PDF pass-through function can be enabled if the document generation application 315 can output a PDF file. The OS 313 receives the PDF file and the print settings from the document generation application 315. In step S820, the OS 313 transmits the received PDF file and print settings to the print setting extension application 312. The print setting extension application 312 generates print capability information based on the received print settings, with the received PDF file intact. In step S821, the print setting extension application 312 transmits the PDF file and the generated print capability information to the OS 313.

In step S818, the OS 313 transmits the print data and the print capability information passed from the print setting extension application 312, or the print data and the print capability information generated by the OS 313, to the cloud print service 321 via the print queue.

In step S819, the cloud print service 321 transmits the print data and the print capability information transmitted from the client terminal 101 to the cloud print compatible printer 104.

The cloud print compatible printer 104 may regularly inquire of the cloud print service 321 and acquire unprinted print data held on the cloud print service 321 and print capability information corresponding to the print data. In the processing of step S801 in FIG. 8A, the capability information is acquired at the timing when the printer name is selected by the document generation application 315, and then the subsequent processing is performed up to the display of the print setting screen. However, such processing may be started at other timing. For example, the foregoing processing may be started at timing when the object 1104 displayed on the document generation application 315 is pressed.

In the procedure described above, if the print queue and the print setting extension application 312 are liked, the extended print setting screen (FIGS. 10A to 10E) of the print setting extension application 312 is displayed at the timing when the print queue is selected, and then printing is performed.

The above is the description of the print setting extension application 312 and the entire printing procedure using the print setting extension application 312. A more detailed description of the PDF pass-through function will now be given.

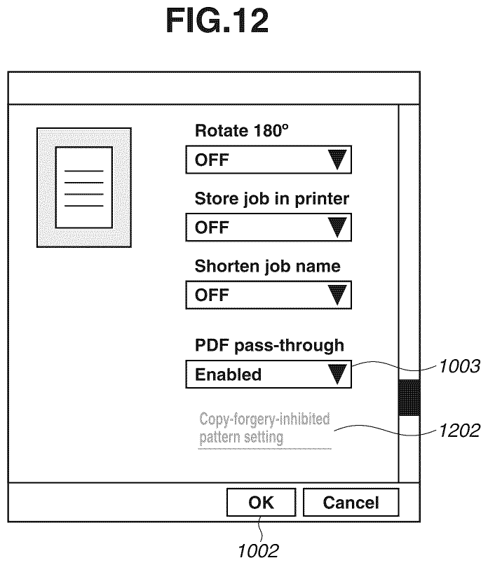

FIG. 12 illustrates an extended print setting screen displayed when the PDF pass-through function is enabled on the print setting screen illustrated in FIG. 10D.

The list box 1003 is the object for the user to enable and disable the PDF pass-through function. If the PDF pass-through function is set to “enabled”, the print setting extension application 312 receives the PDF file output by the document generation application 315 and the print settings. The print setting extension application 312 converts the print settings into IPP-defined attribute values to generate print capability information without converting the file format of the PDF file, and transmits the PDF file and the print capability information to the OS 313. The print setting extension application 312 does not convert attribute values not defined by the IPP and simply transmits such attribute values to the OS 313. If the PDF pass-through function is set to “disabled”, the OS 313 once converts the PDF file output by the document generation application 315 into an XPS file. The print setting extension application 312 receives the converted XPS file and the print settings. The print setting extension application 312 converts the XPS file into a PDF file, generates print capability information indicating the print settings in terms of IPP-defined attribute values, and transmits the PDF file and the print capability information to the OS 313.

A “copy-forgery-inhibited pattern setting” 1202 is a function of adding an image of a predetermined character string or an image of a user-set character string to image data output by the document generation application 315. If the “copy-forgery-inhibited pattern setting” 1202 is selected, a not-illustrated copy-forgery-inhibited pattern setting screen is displayed. The copy-forgery-inhibited pattern setting screen can set whether to enable or disable the copy-forgery-inhibited pattern function, the font size of the characters to be added to the image data output by the document generation application 315, the character string, a font type, color, a dot pattern, and the layout of the character string.

If the OK button 1002 is selected, the extended print setting screen illustrated in FIG. 12 is hidden and the print setting initial screen illustrated in FIG. 11 is displayed.

In the present exemplary embodiment, if the PDF pass-through function is enabled in the list box 1003, the “copy-forgery-inhibited pattern setting” 1202 is grayed out to not be settable. The “copy-forgery-inhibited pattern setting” 1202 is a function of editing a file of the XPS format into which the file generated by the document generation application 315 is converted by the OS 313, and adding image data thereto. If the print setting extension application 312 receives data of the PDF format, the image editing is therefore unable to be performed. In the present exemplary embodiment, if the PDF pass-through function is enabled, the print setting extension application 312 controls the “copy-forgery-inhibited pattern setting” 1202 so that the “copy-forgery-inhibited pattern setting” 1202 is not settable. In FIG. 12, the “copy-forgery-inhibited pattern setting” 1202 is grayed out if the PDF pass-through function is enabled. The display mode is not limited to gray-out. For example, the “copy-forgery-inhibited pattern setting” 1202 may be hidden if the PDF pass-through function is enabled. Alternatively, the “copy-forgery-inhibited pattern setting” 1202 may be displayed regardless of whether the PDF pass-through function is enabled or disabled, and an error notification may be displayed if the user selects the “copy-forgery-inhibited pattern setting” 1202 with the PDF pass-through function enabled. The foregoing error notification refers to a notification that the copy-forgery-inhibited pattern function is not usable with the PDF pass-through function enabled. Alternatively, both the PDF pass-through function and the copy-forgery-inhibited pattern setting may be settable on the extended print setting screen, and if the PDF pass-through function and the copy-forgery-inhibited pattern setting are both enabled, the print processing may be performed with either one of the functions disabled.

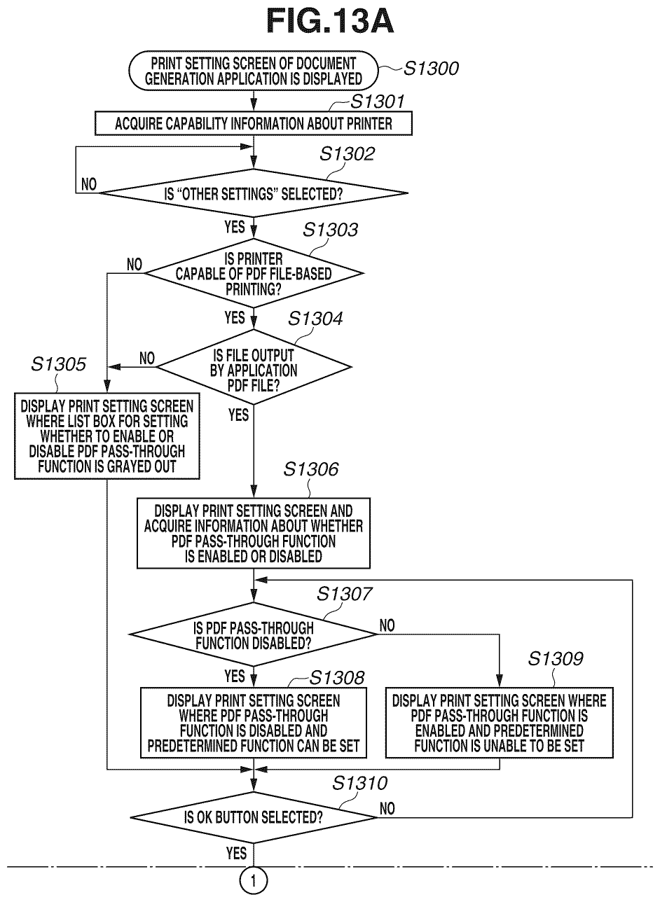

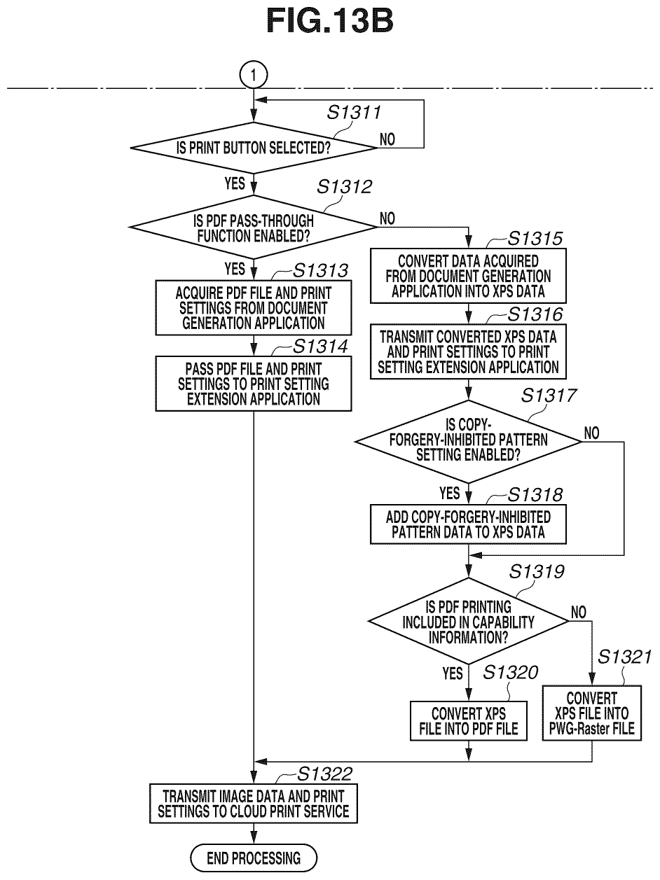

Next, a method for displaying a button for switching the PDF pass-through function on and off in a case where the data to be printed is PDF data according to the present exemplary embodiment will be described with reference to FIGS. 13A and 13B.

This processing is implemented by loading a program for performing the processing into the memory 213 of FIG. 2A and executing the program by the CPU 212.

The processing starts with the client terminal 101 activated and with the print setting screen (FIG. 11) of the document generation application 315 displayed in step S1300. The following description will be given on the assumption that the printer name of the print queue associated with the print setting extension application 312 is selected using the object 1101 of FIG. 11.

In step S1301, the CPU 212 acquires the capability information about the printer stored in association with the print queue of the selected printer name. The CPU 212 performs the processing of step S1301 by executing the print setting extension application 312. While processing for reading the capability information about the printer stored in the client terminal 101 is intended to be performed here, the processing for acquiring the capability information may be implemented by accessing the cloud print service 321 at this timing.

In step S1302, the CPU 212 determines whether the “other settings” object 1104 on the print setting screen illustrated in FIG. 11 is selected. This determination is made using the document generation application 315 that displays the print setting screen of FIG. 11. The CPU 212 repeats the processing of step S1302 until the “other settings” object 1104 is selected. If the “other settings” object 1104 is selected, the OS 313 is notified by the document generation application 315. The OS 313 notified selects the print setting extension application 312 linked with the print queue of the selected printer name, and instructs the print setting extension application 312 to display the extended print setting screen.

In step S1303, the CPU 212 determines whether the printer of the selected printer name is capable of performing PDF file-based printing, based on the capability information acquired in step S1301. Step S1303 is implemented by the CPU 212 executing the program of the print setting extension application 312. Whether the printer is capable of processing a PDF file is determined based on whether a character string “PDF” is included in the description of the capability information illustrated in FIG. 17. If PDF printing is not included in the capability information, i.e., the printer corresponding to the selected print queue is not capable of PDF printing (NO in step S1303), the processing proceeds to step S1305. If PDF printing is included in the capability information (YES in step S1303), the processing proceeds to step S1304.

In step S1304, the CPU 212 determines whether the file output by the document generation application 315 is a PDF file. The determination in step S1304 is made based on whether a character string “% PDF” is included at the beginning of the file to be printed, for example. The processing of step S1304 is implemented by the CPU 212 executing the print setting extension application 312. Alternatively, the processing of step S1304 may be implemented as follows: The CPU 212 acquires the ID of the application giving an instruction to display the print setting screen based on the program of the print setting extension application 312. If the acquired application ID is that of a predetermined application, the document generation application 315 may be determined to output a PDF file and the processing may proceed to step S1306. The ID of the application instructing the print setting extension application 312 to display the print setting screen is acquired by using an API provided by the OS 313.

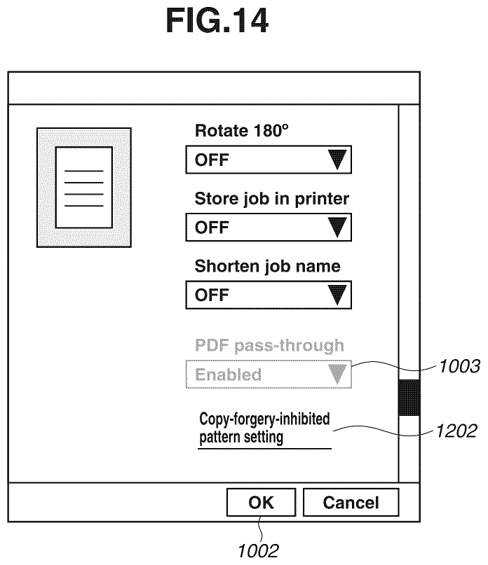

In step S1305, the CPU 212 displays the print setting screen where the list box 1003 for setting whether to enable or disable the PDF pass-through function is grayed out, based on the print setting extension application 312. A print setting screen such as illustrated in FIG. 14 is displayed by performing step S1305. Since the list box 1003 is grayed out, the setting value is unable to be changed from disabled to enabled. The “copy-forgery-inhibited pattern setting” 1202 is operably displayed. If the “copy-forgery-inhibited pattern setting” 1202 is selected, the not-illustrated copy-forgery-inhibited pattern setting screen is displayed. In the present exemplary embodiment, the list box 1003 is grayed out to perform control so as not to change setting of the PDF pass-through function. In step S1305, the list box 1003 may be hidden to prevent the PDF pass-through function from being enabled.

In step S1306, the CPU 212 acquires information about whether the PDF pass-through function is enabled or disabled, based on the program of the print setting extension application 312. The CPU 212 acquires information indicating the current print settings from the OS 313. In step S1307, the CPU 212 refers to the acquired current print settings, and determines whether the PDF pass-through function is enabled or disabled.

If the PDF pass-through function is disabled (YES in step S1307), the processing proceeds to step S1308. In step S1308, the CPU 212 displays a print setting screen where the PDF pass-through function is disabled and a predetermined function can be set, based on the program of the print setting extension application 312. FIG. 10D illustrates the print setting screen displayed in step S1308.

If the PDF pass-through function is enabled (NO in step S1307), the processing proceeds to step S1309. In step S1309, the CPU 212 displays a print setting screen where the PDF pass-through function is enabled and the predetermined function is grayed out, based on the program of the print setting extension application 312. FIG. 12 illustrates the print setting screen displayed in step S1309.

In step S1310, the CPU 212 determines whether the OK button 1002 is selected, based on the program of the print setting extension application 312. If the OK button 1002 is not selected (NO in step S1310), the processing returns to step S1307. In the subsequent processing of steps S1307 to S1309, if the setting of the PDF pass-through function is not changed, the display related to the PDF pass-through is not changed. If the user changes the setting of the PDF pass-through function, the processing of step S1308 or S1309 is performed accordingly.

If the OK button 1002 is selected (YES in step S1310), the processing proceeds to step S1311. The CPU 212 transmits the current print settings to the OS 313 and ends the display of the print setting screen, based on the program of the print setting extension application 312. The print setting screen illustrated in FIG. 11 is thereby displayed. Here, the print setting initial screen on which the print settings made via the extended print setting screen provided by the print setting extension application 312 are reflected is displayed.

In step S1311, the CPU 212 determines whether the “print” button 1105 is selected, based on the program of the document generation application 315. If the “print” button 1105 is not selected (NO in step S1311), the processing returns to step S1311. If in the meantime the print settings are changed via the print setting initial screen, the CPU 212 performs processing for changing the print settings. If in the meantime the instruction to display the extended print setting screen is given again, the processing of step S1303 to S1310 is repeated.

If the “print” button 1105 is selected (YES in step S1311), the processing proceeds to step S1312. In step S1312, the CPU 212 notifies the OS 313 that a print instruction is given. The CPU 212 executes the program of the OS 313 to acquire the print settings and determine whether the PDF pass-through function is enabled. If the PDF pass-through function is enabled (YES in step S1312), the processing proceeds to step S1313. On the other hand, if the PDF pass-through function is disabled (NO in step S1312), the processing proceeds to step S1315.

In step S1313, the CPU 212 acquires the PDF file and the print settings from the document generation application 315 based on the program of the OS 313. In step S1314, the CPU 212 passes the acquired PDF file and print settings to the print setting extension application 312. Here, the CPU 212 simply transmits the PDF file received from the document generation application 315 to the print setting extension application 312 without changing the content of the PDF file.

Next, the operation in the case where the PDF pass-through function is disabled will be described.

In step S1315, the CPU 212 acquires data from the document generation application 315 and converts the data format into XPS based on the program of the OS 313. Here, the CPU 212 also receives the print settings from the document generation application 315 based on the program of the OS 313.

In step S1316, the CPU 212 transmits the converted XPS data and the print settings to the print setting extension application 312 based on the program of the OS 313.

In step S1317, the CPU 212 refers to the copy-forgery-inhibited pattern setting in the received print settings and determines whether the copy-forgery-inhibited pattern setting is enabled, based on the program of the print setting extension application 312. If the copy-forgery-inhibited pattern setting is enabled (YES in step S1317), the processing proceeds to step S1318. In step S1318, the CPU 212 adds copy-forgery-inhibited pattern image data to the XPS data received from the OS 313, based on the program of the print setting extension application 312. The CPU 212 edits the XPS data based on the character string to be printed as a copy-forgery-inhibited pattern, the character size, the font, and the character color that are set as the copy-forgery-inhibited pattern setting. If the copy-forgery-inhibited pattern setting is disabled (NO in step S1317), the processing proceeds to step S1319.

In step S1319, the CPU 212 refers to the capability information corresponding to the selected print queue and determines whether PDF printing is included in the capability information, based on the program of the print setting extension application 312. If PDF printing is included in the capability information (YES in step S1319), the processing proceeds to step S1320. In step S1320, the CPU 212 generates a PDF file based on the XPS file (XPS data), based on the program of the print setting extension application 312. The CPU 212 converts the XPS file into the PDF file based on the program of the print setting extension application 312, using an API provided by the OS 313. The CPU 212 also converts the print settings into IPP-defined attribute values. If the print settings include attributes not defined by the IPP, the attributes are not converted.

If, in step S1319, PDF printing is determined to not be included in the capability information (NO in step S1319), the processing proceeds to step S1321. In step S1321, the CPU 212 generates a PWG-Raster file based on the program of the print setting extension application 312. The CPU 212 converts the XPS file into the PWG-Raster file based on the program of the print setting extension application 312, using an API of the OS 313. In step S1321, like step S1320, the CPU 212 also converts the print settings into IPP-defined attribute values.

In step S1322, the CPU 212 registers the generated image data and the print settings in the print queue based on the program of the print setting extension application 312. The CPU 212 transmits the registered image data and print settings to the cloud print service 321 in conformity to the IPP, based on the program of the OS 313.

In such a manner, the processing illustrated in FIGS. 13A and 13B ends. The PDF pass-through function can thus be set on the print setting screen provided by the print setting extension application 312. The print setting extension application 312 can also prevent the user from setting a function that is unusable with the PDF pass-through function enabled.

In the first exemplary embodiment, the method for displaying the button for switching the PDF pass-through function on and off in the case where the file output from the document generation application 315 is a PDF file has been described. For a PDF file, the user can set a given character string as a password. If a password is set, the PDF file can be opened by inputting the set password. In printing a PDF file for which a password is set, the password can be input.

In a second exemplary embodiment, a processing method for displaying a box for inputting a password if a password is input in printing a PDF file will be described.

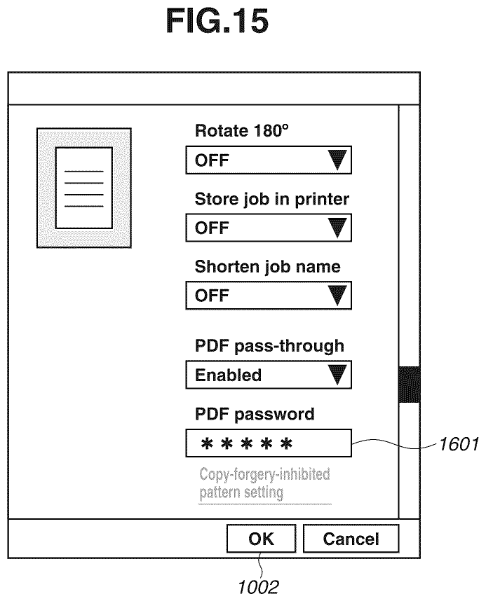

The processing method for displaying a box for inputting a password if a password is input in printing a PDF file according to the present exemplary embodiment will be described with reference to FIG. 15.

FIG. 15 illustrates a print setting screen displayed by a print setting extension application 312, a screen corresponding to FIG. 12 of the first exemplary embodiment. A difference from the first exemplary embodiment is that there is a password input area 1601 for inputting a password of a PDF file. If the PDF pass-through function is disabled, the password input area 1601 is grayed out to not accept input. If the PDF pass-through function is enabled, the password input area 1601 becomes capable of character input. In FIG. 15, the input characters are converted and displayed as asterisks. The characters input to the password input area 1601 may simply be displayed. A plurality of password input areas may be displayed.

If an OK button 1002 is selected on the print setting screen of FIG. 15, the print setting screen of FIG. 11 is displayed. If the user selects a “print” button 1105 on the print setting screen illustrated in FIG. 11, processing is performed.

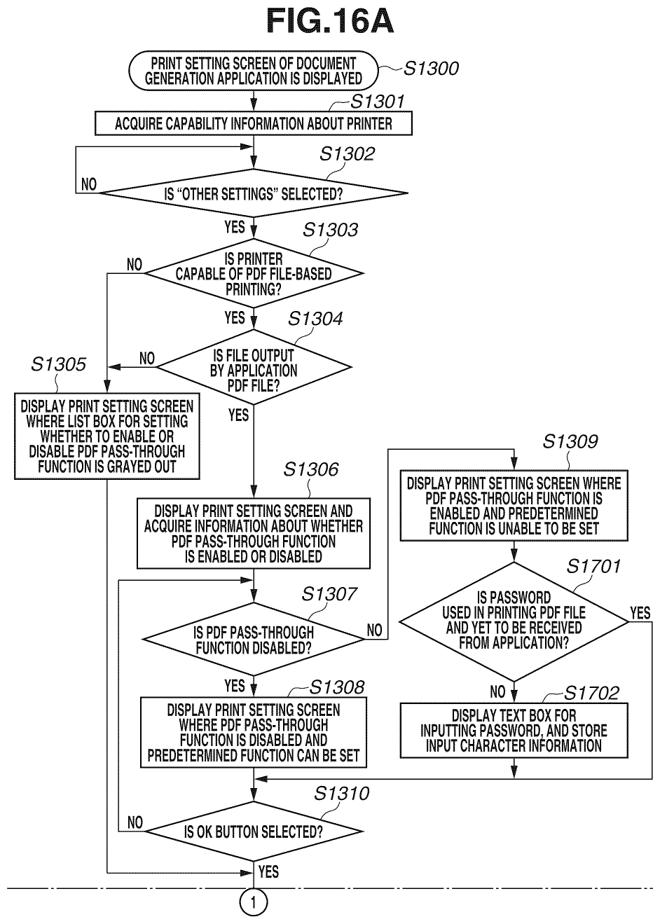

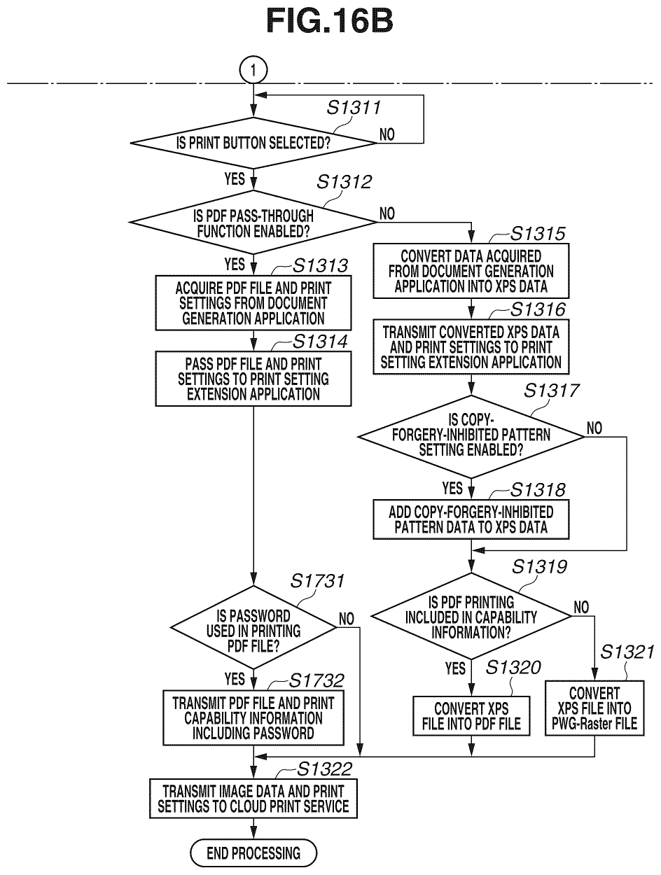

The processing according to the second exemplary embodiment will be described with reference to FIGS. 16A and 16B. The processing of FIGS. 16A and 16B is implemented by a CPU 212 of a client terminal 101 executing a program of an OS 313 or the print setting extension application 312. Processing similar to that of FIGS. 13A and 13B is denoted by the same step numbers as in FIGS. 13A and 13B. A description thereof will be omitted.

The processing is started with the client terminal 101 activated and with the print setting screen (FIG. 11) of a document generation application 315 displayed in step S1300.

In step S1309, the CPU 212 disables items that are not settable with the PDF pass-through function enabled, like “copy-forgery-inhibited pattern setting” 1202, based on the program of the print setting extension application 312.

In step S1701, the CPU 212 determines whether a password is used in printing a PDF file and yet to be received from an application, based on the program of the print setting extension application 312.

If the determination of step S1701 is no (NO in step S1701), the processing proceeds to step S1702. In step S1702, the CPU 212 displays a text box for inputting a password and stores character information input to the text box as a print setting, based on the program of the print setting extension application 312. FIG. 15 illustrates an example of the print setting screen displayed in step S1702.

If the determination of step S1701 is yes (YES in step S1701), the processing proceeds to step S1310.

The processing of steps S1310 to S1321 is similar to that in FIGS. 13A and 13B. A description thereof will thus be omitted.

After step S1314, i.e., in step S1731, the CPU 212 determines whether a password is used in printing the received PDF file, based on the program of the print setting extension application 312.

If the determination of step S1731 is no (NO in step S1731), the processing proceeds to step S1322.

If the determination of step S1731 is yes (YES in step S1731), the processing proceeds to step S1732.

In step S1732, the CPU 212 generates print capability information including the password set via the extended print setting screen provided by the print setting extension application 312, and transmits the PDF file and the print capability information to the print queue. In step S1322, the CPU 212 transmits the PDF file and the print capability information (print settings) to the cloud print service 321 based on the program of the OS 313.

In opening the received PDF file, a cloud print compatible printer 104 determines whether a password is used. If a password is determined to be used, the cloud print compatible printer 104 determines whether the received print capability information includes a password. If the print capability information does not include a password, the cloud print compatible printer 104 is unable to open or print the PDF file, and thus issues an error notification to a display unit 246. The error notification may be issued by turning on the LED of the cloud print compatible printer 104 or by voice. The cloud print compatible printer 104 is also unable to print if a password is used in opening the received PDF file and the PDF file is unable to be opened by the password described in the print capability information. In such a case, the cloud print compatible printer 104 similarly displays an error on the display unit. The error displayed here may include a similar message to that when the print capability information does not include a password, or a different message.

If a password is used in opening the received PDF file and the PDF file is successfully opened by the password described in the received print capability information, the cloud print compatible printer 104 performs image formation based on the opened PDF file and the print capability information.

If a password is not needed to open the received PDF file, the cloud print compatible printer 104 opens the PDF file, and performs image forming processing by performing layout processing based on the print capability information.

The above is the processing performed in the second exemplary embodiment. In the foregoing description, the client terminal 101 is described to transmit the PDF file and the print capability information including the password to the cloud print service 321, and the cloud print service 321 is described to transmit the PDF file and the print capability information to the cloud print compatible printer 104. However, the print setting extension application 312 may open the PDF file received from the OS 313 using the password described in the print settings, and transmit the opened PDF file and the print capability information to the cloud print compatible printer 104 via the cloud print service 321.

In such a manner, encrypted PDF files can also be printed by using the PDF pass-through function.

### Other Exemplary Embodiments

In the first and second exemplary embodiments, the PDF file and the print capability information transmitted from the client terminal 101 are described to be transmitted to the cloud print compatible printer 104 via the cloud print service 321. However, the exemplary embodiments may be applied to cases where the client terminal 101 and the cloud print compatible printer 104 are directly connected without the cloud print service 321.

In the first and second exemplary embodiments, whether to enable or disable the PDF pass-through function is set on the print setting screen that is displayed by the print setting extension application 312 when the “other settings” object 1104 is selected on the print setting initial screen illustrated in FIG. 11. Alternatively, the print setting extension application 312 may display an object for setting whether to perform PDF pass-through when the user selects the “print” button 1105 on the print setting initial screen illustrated in FIG. 11. In such a case, the print setting extension application 312 may display an object of a setting item related to the PDF pass-through function along with the object for setting whether to enable the PDF pass-through function. Examples of the setting item related to the PDF pass-through function include a setting item that can interfere with the PDF pass-through function (copy-forgery-inhibited pattern setting), and a password for opening the PDF file.

An exemplary embodiment of the present disclosure is also implemented by performing the following processing. The processing includes supplying software (program) for implementing the functions of the foregoing exemplary embodiments to a system or an apparatus via a network or various storage media, and reading and executing the program code by a computer (or CPU or microprocessing unit [MPU]) of the system or apparatus. In such a case, the computer program and the storage medium storing the computer program constitute an exemplary embodiment of the present disclosure. In the foregoing exemplary embodiments, capability information and print data are described to be communicated via the cloud print service 321. However, capability information and print data may be directly communicated with the cloud print compatible printer 104.

An information processing apparatus according to an exemplary embodiment of the present disclosure can, in opening a PDF file with an application and printing the PDF file using a general-purpose printer driver, easily switch whether to print by once converting the PDF file into an XPS file or without the conversion.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-024844, filed Feb. 21, 2023, which is hereby incorporated by reference herein in its entirety.

What is claimed is:

1. An information processing apparatus comprising:
a conversion unit configured to convert a file of a first format output by an application into a file of a second format;
a generation unit configured to generate print data based on the converted file; and
a transmission unit configured to transmit the print data generated by the generation unit,
wherein the transmission unit is configured to transmit the file output by the application without conversion based on a user's instruction to transmit the file output by the application without conversion.

2. The information processing apparatus according to claim 1, further comprising a control unit configured to display an object configured to accept the user's instruction on a display unit.

3. The information processing apparatus according to claim 2, wherein the control unit is configured to control not to accept a setting of a function not to be performed on the file of the first format output by the application based on acceptance of the user's instruction.

4. The information processing apparatus according to claim 2, further comprising a determination unit configured to determine whether a file-providing application is an application configured to output a file of a predetermined format,
wherein the control unit is configured to, in a case where the file-providing application is determined to be an application configured to output a file of the first format by the determination unit, display the object on the display unit.

5. The information processing apparatus according to claim 1, wherein the first format is Portable Document Format (PDF).

6. The information processing apparatus according to claim 5, wherein the second format is Extensible Markup Language (XML) Paper Specification (XPS).

7. A control method of an information processing apparatus, the control method comprising:
converting a file of a first format output by an application into a file of a second format;
generating print data based on the converted file;
transmitting the generated print data; and
transmitting the file output by the application without conversion based on a user's instruction to transmit the file output by the application without conversion.

8. The control method according to claim 7, further comprising controlling display of an object configured to accept the user's instruction on a display unit.

9. The control method according to claim 8, wherein control is performed not to accept a setting of a function not to be performed on the file of the first format output by the application based on acceptance of the user's instruction.

10. The control method according to claim 8, further comprising determining whether a file-providing application is an application configured to output a file of a predetermined format,
wherein the controlling includes, in a case where the file-providing application is determined to be an application configured to output a file of the first format, displaying the object on the display unit.

11. The control method according to claim 7, wherein the first format is PDF.

12. The control method according to claim 11, wherein the second format is XPS.

13. The control method according to claim 7, wherein a file of the first format is generated based on the file of the second format.

14. A non-transitory computer-readable storage medium storing executable instructions, which when executed by one or more processors of an information processing apparatus, cause the information processing apparatus to perform a control method, the control method comprising:
converting a file of a first format output by an application into a file of a second format;
generating print data based on the converted file;
transmitting the generated print data; and
transmitting the file output by the application without conversion based on a user's instruction to transmit the file output by the application without conversion.

15. The non-transitory computer-readable storage medium according to claim 14, the control method further comprising controlling display of an object configured to accept the user's instruction on a display unit.

16. The non-transitory computer-readable storage medium according to claim 15, wherein control is performed not to accept a setting of a function not to be performed on the file of the first format output by the application based on acceptance of the user's instruction.

17. The non-transitory computer-readable storage medium according to claim 15, the control method further comprising determining whether a file-providing application is an application configured to output a file of a predetermined format,
wherein the controlling includes, in a case where the file-providing application is determined to be an application configured to output a file of the first format, displaying the object on the display unit.

18. The non-transitory computer-readable storage medium according to claim 14, wherein the first format is PDF.

19. The non-transitory computer-readable storage medium according to claim 18, wherein the second format is XPS.

20. The non-transitory computer-readable storage medium according to claim 14, wherein a file of the first format is generated based on the file of the second format.
